(19) United States
(12) Patent Application Publication
(10) Pub. No.: US 2024/0037338 A1
(43) Pub. Date: Feb. 1, 2024

(54) METHODS AND APPARATUSES FOR GENERATING DIALOGUE ANNOTATION DATA

(71) Applicant: Alipay (Hangzhou) Information Technology Co., Ltd., Hangzhou, Zhejiang (CN)

(72) Inventors: Zhiheng Zhou, Hangzhou (CN); Peng Xu, Hangzhou (CN); Jing Zheng, Hangzhou (CN); Yi Su, Hangzhou (CN); Zhongnan Shen, Hangzhou (CN)

(73) Assignee: Alipay (Hangzhou) Information Technology Co., Ltd., Hangzhou, Zhejiang (CN)

(21) Appl. No.: 18/363,504

(22) Filed: Aug. 1, 2023

(30) Foreign Application Priority Data
Aug. 1, 2022 (CN) 202210917683.1

(51) Int. Cl. G06F 40/289; G06F 40/35; G06F 40/242

(52) U.S. Cl. CPC G06F 40/289; G06F 40/35; G06F 40/242

(57) ABSTRACT

Embodiments of this specification provide for generating dialogue annotation data. A method includes: obtaining grammar that has been pre-generated in a target scenario, the grammar including a first phrase and a second phrase; the first phrase includes a first intent operation and a first variable of a first intent, where the first variable invokes other phrases. The second phrase assigns a value to the first variable and includes a property acquisition operation and a second variable of a second intent. Generating a target meaning representation of nested phrases for simulating a certain human-machine dialogue by invoking the first phrase and the second phrase in the grammar. Performing the first intent operations based on a property value corresponding to the first variable of the second variable assigned to the first variable.

### CROSS-REFERENCE TO RELATED APPLICATIONS

This application claims priority to Chinese Patent Application No. 202210917683.1, filed on Aug. 1, 2022, which is hereby incorporated by reference in its entirety.

### TECHNICAL FIELD

One or more embodiments of this specification relate to the technical field of computers, in particular to methods and apparatuses for generating dialogue annotation data.

### BACKGROUND

With the continuous development of artificial intelligence (AI) technology, more and more industries use human-machine dialogue interaction systems such as an intelligent assistant, an intelligent customer service, and a vending machine, to provide users with information or services such as weather information, ticket information, or ticket booking.

Usually, the human-machine dialogue interaction system responds to inputs of a user in a question-and-answer manner through a dialogue interaction interface. For interaction with the user, the system needs to first identify intent information corresponding to phrases entered by the user in each round, and then determines answers of the system in that round. In order to improve the validity of human-machine interactions and thus improve the user experience, it is necessary to accurately identify the intent information.

At present, training machine learning models for identifying user's intent information has become a research hotspot. The functions and effects that the machine learning model strongly depend on structures, quantities, and quality of dialogue annotation data. However, there are limited ways to obtain dialogue annotation data.

Therefore, there is a need for a solution that can automatically generate dialogue annotation data that can meet higher application needs and train highly functional machine learning models that support more complex human-machine interactions with users, thereby effectively improving the user experience.

### SUMMARY

One or more embodiments of this specification provide methods for generating dialogue annotation data. Dialogue annotation data that support intent nesting can be generated. A semantic parsing model trained by using the dialogue annotation data can be used to simultaneously identify a plurality of intents in a user conversation.

According to a first aspect, a method for generating dialogue annotation data is provided, including the following steps: A grammar that has been pre-generated in a target scenario is obtained, wherein the grammar at least includes a first phrase and a second phrase; the first phrase includes a first intent operation of a first intent and a first variable of the first intent; the first variable is a variable that invokes other phrases; and the second phrase is configured to assign a value to the first variable and includes a property acquisition operation and a second variable of a second intent. A target meaning representation for simulating a certain human-machine dialogue in the target scenario is generated by at least invoking the first phrase and the second phrase in the grammar, wherein the target meaning representation is shown in the form of nested phrases. A property value, corresponding to the first variable, of the second variable is assigned to the first variable, and the first intent operation is performed. Dialogue annotation data are generated on the basis of the target meaning representation, wherein the dialogue annotation data include multiple conversation-tag groups corresponding respectively to multiple rounds of dialogues that form the certain human-machine dialogue, and the single conversation-tag group includes a user conversation in one round of dialogue and a meaning representation tag corresponding to the user conversation.

In one or more embodiments, a grammar that has been pre-generated in a target scenario is generated, including the following: Scenario information is obtained, wherein the scenario information includes multiple domains involved in the target scenario, multiple user intents in each of the multiple domains, and multiple slots under each of the multiple user intents. Dictionary information is obtained, wherein the dictionary information includes one or more dictionaries corresponding to each slot, and the dictionaries include candidate slot values of each slot. The grammar is generated on the basis of the scenario information, the dictionary information, and a predefined phrase template.

In one or more embodiments, the first intent and the second intent belong to the same domain or different domains.

In one or more embodiments, the grammar includes a start phrase with a start symbol, wherein a target meaning representation for simulating a certain human-machine dialogue in the target scenario is generated by at least invoking the first phrase and the second phrase in the grammar, including the following: The start phrase is used as a current meaning representation, and the current meaning representation is updated by invoking a plurality of other phrases in the grammar one after another until the current meaning representation is unable to perform phrase invocation, so as to use the current meaning representation as the target meaning representation, wherein the plurality of phrases include the first phrase and the second phrase.

In one or more specific embodiments, the grammar further includes a third phrase; and the third phrase includes a third intent and is configured to assign a value to the first variable, wherein the current meaning representation is updated by invoking a plurality of other phrases phrase in the grammar one after another, including the following: After the first phrase is invoked, one of the second phrase or the third phrase is selected on the basis of a predetermined intent nesting probability related to the second intent and the third intent. In a case that a selection result indicates that the second phrase is selected, the second phrase is invoked to assign a value to the first variable.

In one or more embodiments, the grammar further includes a fourth phrase; the fourth phrase includes a third intent operation of a third intent, a fourth intent operation of a fourth intent, and a fourth variable of the fourth intent, and a variable value of the fourth variable is defined as; an operation result of the third intent operation corresponds to a property value of the fourth variable; and the fourth phrase indicates simultaneously outputting the operation result of the third intent operation and an operation result of the fourth intent operation.

In one or more embodiments, dialogue annotation data are generated on the basis of the target meaning representation, including the following: The target meaning representation is divided into a plurality of sub-representations on the basis of a data flow direction in the target meaning representation. The corresponding conversation-tag groups are generated for the respective sub-representations. The plurality of conversation-tag groups corresponding to the plurality of sub-representations are sequentially concatenated to obtain the dialogue annotation data.

In one or more specific embodiments, the target meaning representation involves a plurality of user intents; and the target meaning representation is divided into a plurality of sub-representations on the basis of a data flow direction in the target meaning representation, including the following: The target meaning representation is divided into a plurality of intent representations corresponding to the plurality of user intents. Group combination is performed on the plurality of intent representations on the basis of the data flow direction to obtain the plurality of sub-representations.

In one or more specific embodiments, group combination is performed on the plurality of intent representations on the basis of the data flow direction to obtain the plurality of sub-representations, including the following: Each of the plurality of intent representations is used as a corresponding sub-representation.

In one or more examples, the corresponding conversation-tag groups are generated for the respective sub-representations, including the following: For a first sub-representation corresponding to the first intent, a corresponding user conversation template is obtained on the basis of the first intent operation, the first variable, the second variable, and the property acquisition operation, wherein the second variable is used to describe the first variable. A corresponding first user conversation is generated on the basis of the property value of the second variable and the user conversation template, and the first user conversation and the first sub-representation are used as one conversation-tag group.

In one or more embodiments, the grammar includes a plurality of phrases and user conversation generation templates corresponding to the respective phrases, wherein a target meaning representation for simulating a certain human-machine dialogue in the target scenario is generated by at least invoking the first phrase and the second phrase in the grammar, including the following: The target meaning representation is generated by invoking some phrases phrase in the grammar, and a corresponding target user conversation is generated by invoking some user conversation generation templates corresponding to the phrases, wherein dialogue annotation data are generated on the basis of the target meaning representation, including the following: One conversation-tag group is generated by using the target meaning representation as the meaning representation tag of the target user conversation.

In one or more embodiments, the meaning representation tag is in a computer code form executable by a computer.

In one or more embodiments, the method further includes the following: A user conversation-oriented semantic parsing model in a human-machine dialogue scenario is trained by using the dialogue annotation data.

According to a second aspect, an apparatus for generating dialogue annotation data is provided, including: a grammar acquisition unit, configured to obtain a grammar that has been pre-generated in a target scenario, wherein the grammar at least includes a first phrase and a second phrase; the first phrase includes a first intent operation of a first intent and a first variable of the first intent; the first variable is a variable that invokes other phrases; and the second phrase is configured to assign a value to the first variable and includes a property acquisition operation and a second variable of a second intent; a target representation generation unit, configured to generate, by at least invoking the first phrase and the second phrase in the grammar, a target meaning representation for simulating a certain human-machine dialogue in the target scenario, wherein the target meaning representation is shown in the form of nested phrases; assign a property value, corresponding to the first variable, of the second variable to the first variable, and perform the first intent operation; and an annotation data generation unit, configured to generate dialogue annotation data on the basis of the target meaning representation, wherein the dialogue annotation data include multiple conversation-tag groups corresponding to multiple rounds of dialogues that form the certain human-machine dialogue, and the single conversation-tag group includes a user conversation in one round of dialogue and a meaning representation tag corresponding to the user conversation.

According to a third aspect, a computer-readable storage medium is provided, storing a computer program. The computer program, when run in a computer, causes the computer to perform the method of the first aspect.

According to a fourth aspect, a computer device is provided, including a memory and a processor. The memory stores an executable code, and when executing the executable code, the processor implements the method of the first aspect.

The methods and apparatuses provided by the embodiments of this specification are used to obtain a pre-generated grammar that supports multi-intent interactions in a target scenario, invoke specific types of grammar phrases on the basis of the grammar, generate a target meaning representation including nested intents, then simulate a certain human-machine conversation on the basis of the target meaning representation, and generate multiple conversation-tag groups corresponding to multiple rounds of conversations as dialogue annotation data. In at least one conversation-tag group in the dialogue annotation data, a meaning representation tag includes a nested or linear combination of intents, and a corresponding user conversation includes using a slot of one intent to describe the same slot of another intent. As such, the dialogue annotation data for human-machine interactions in a multi-intent scenario are generated.

### BRIEF DESCRIPTION OF DRAWINGS

For clearer descriptions of the technical solutions according to the embodiments of this application, the drawings needed to be used in the description of the embodiments are briefly introduced below. It is clear that the drawings in the description below are only some embodiments of this application, and it is obvious for a person of ordinary skill in the art that other drawings can be obtained on the basis of these drawings without creative efforts.

FIG. 1 is a schematic block diagram illustrating generation of dialogue annotation data according to one or more embodiments;

FIG. 2 is a flowchart illustrating a method for generating dialogue annotation data according to one or more embodiments; and

FIG. 3 is a schematic structural diagram illustrating an apparatus for generating dialogue annotation data according to one or more embodiments.

### DESCRIPTION OF EMBODIMENTS

The solutions provided in this specification are described below in combination with the drawings.

As mentioned above, training machine learning models for identifying user's intent information in a human-machine interaction scenario has become a research hotspot. For clarity of description, this machine learning model may be referred to as a semantic parsing model in the text. Intent information that can be identified by a traditional semantic parsing model usually includes merely one user intent (or an intent) and multiple slots of the intent during understanding of each round of user conversation. For example, when a phrase of “I want to buy a train ticket to Beijing”, it can be identified that the user intent is “buy a train ticket”, and a slot value of a slot “destination station” in the intent is “Beijing”.

In practical scenarios, it is expected that human-machine interactions can support multi-intent scenarios, even multi-domain and multi-intent scenarios. It means that multiple intents of a user need to be identified simultaneously in a user conversation of one round of dialogue. For example, in a certain dialogue process, the user enters “What are the free attractions near this hotel?”. The sentence is associated with both a hotel intent and an attraction map. It puts higher requirements on the semantic parsing model.

A semantic parsing model applied in a multi-intent human-machine interaction scenario undoubtedly has higher model complexity and has correspondingly higher requirements for the quality and quantity of training data. However, there is actually a lack of available annotation data that support the training of the model. Therefore, there is an urgent need for a solution that can generate dialogue annotation data for a multi-intent human-machine interaction scenario.

A single training sample involved in the dialogue annotation data generally includes a user conversation in a certain round of dialogue and a conversation tag corresponding to the user conservation. Further, the single training sample can also include preceding text of the user conversation, that is, dialogue content of another round that precedes the certain round of dialogue in a certain human-machine dialogue.

It should be understood that the form of the above conversation tag is usually a semantic representation (or a meaning representation (MR)). The meaning representation is computer-executable. Correspondingly, the semantic parsing model is configured to convert a phrase in a Natural Language (NL) into an MR. That is,

Model (the semantic parsing model): NL->MR (meaning representation).

Before the dialogue annotation data are obtained, the meaning representation needs to be defined, including designing an operator, a parameter, and the like of the scenario representation according to the requirements of the application scenario. For example, in an NL2SQL scenario, a phrase in an NL is converted into a phrase in a corresponding Structured Query Language (SQL)phrase. In this case, the meaning representation is in the form of the SQL phrases. Further, related operations such as meeting registration under the task and related parameters such as participants, time, a location, and a meeting topic can be designed according to a requirement of a dialogue task such as a meeting appointment task.

In one manner of obtaining the dialogue annotation data, consider using an existing dialogue system to collect human-machine conversations and then manually add tags to dialogue data. Clearly, this manner requires an operable dialogue system. It is a problem of Chicken or the Egg. In another manner, a human-human dialogue is performed manually, but annotation of the dialogue is still difficult. For example, some scenarios are designed first as a guide of establishing a dialogue, and then dialogues are collected manually. One person adds a user conversation in a current round of conversation on the basis of preceding text of the conversation, while the other person annotates the meaning representation of the user conversation with the help of a tool on the basis of the preceding text of the conversation. A reply is selected as a machine reply from a candidate reply set provided by the tool. It is undoubtedly a very difficult task because annotation personnel need to comprehensively master a grammar and operations of the meaning representation.

In still another manner, consider using a tool to simulate both sides of a dialogue, namely, using a machine-machine manner to generate sentences that are combined into the dialogue, and meaning representations corresponding to the sentences. The combined dialogue sentences are slightly rigid, and are usually rewritten manually afterwards. The manner has two major advantages. Firstly, task scenarios (for example, a task of buying a movie ticket and a task of making a restaurant reservation) that need to be supported can be formulated by the tool, and the coverage of the manner can be guaranteed by the tool. Secondly, while the combined dialogue is generated, a target representation corresponding to the dialogue is generated. As such, the corresponding target representation is still valid as long as the rewritten dialogue maintains its original meaning. The problem left is just writing the sentence in the natural language, and outsourcing personnel do not need to know what the MR is, thereby greatly reducing the working difficulty.

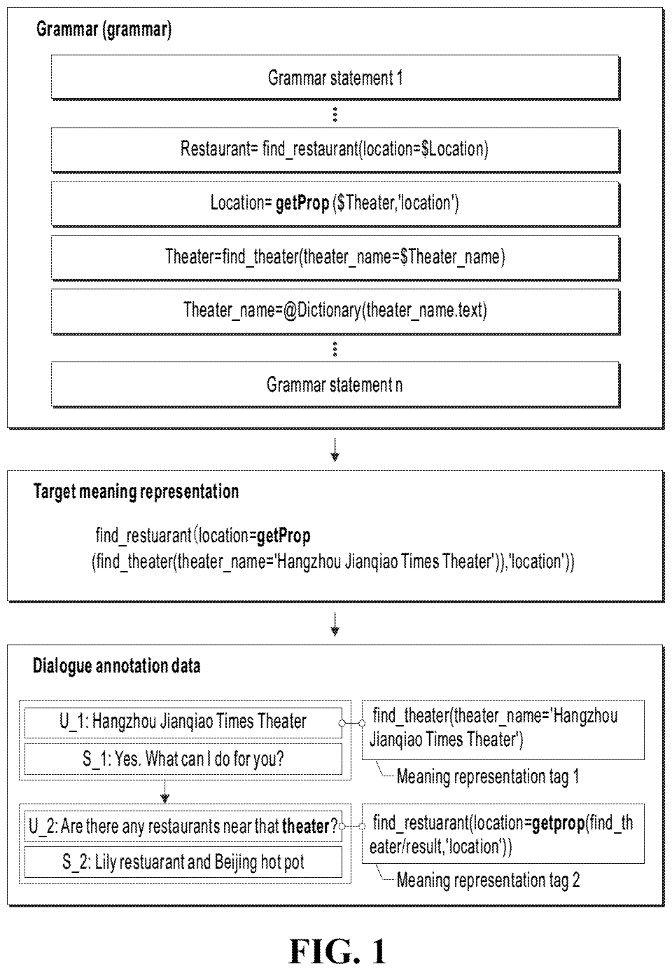

Based on the above observations and analysis, the inventor proposes a solution of automatically generating dialogue annotation data for a multi-intent human-machine interaction scenario on the basis of a machine-machine architecture. FIG. 1 is a schematic block diagram illustrating generation of dialogue annotation data according to one or more embodiments. As shown in FIG. 1, a pre-constructed grammar is obtained first. The grammar can be understood as a grammar that describes an organizational form of a meaning representation. The grammar includes basic grammar phrases (or referred to as grammar phrases or phrases) that constitute different meaning representations, and phrases that support intent nesting are designed in the grammar. To this end, FIG. 1 illustrates the following two example phrases:

Restaurant=find_restuarant(location=$Location);

Location=getProp(STheater,‘location’)

The first phrase represents achieving a find_restuarant intent on the basis of a location variable, and the latter phrase represents obtaining a property value of a location variable corresponding to a theater variable.

Further, a target meaning representation for a certain dialogue (this dialogue has actually not occurred or has not been simulated) on the basis of the constructed grammar. It should be noted that in the embodiments of this specification, related descriptions are made mainly by taking a meaning representation (MR) that is implemented as a function expression (FE) as an example. A meaning representation in another form, such as an SQL, can also be used actually. FIG. 1 illustrates the generated target meaning representation:

find_restuarant(location=getProp(find_theater(theater_name=‘Hangzhou Jianqiao Times Theater’)),‘location’))

Afterwards, the certain dialogue is simulated on the basis of the target meaning representation of the dialogue, and dialogue annotation data corresponding to the certain dialogue is generated in a simultaneous manner. Specifically, the certain dialogue includes multiple rounds of dialogues. The dialogue annotation data include a conversation-tag group corresponding to each of the multiple rounds of dialogues. A conversation refers to a user conversation, and a tag refers a meaning representation tag. For example, a conversation-tag group included in the dialogue annotation data shown in FIG. 1: user conversation U_2—meaning representation tag 2 contains interactions between a theater intent and a restaurant intent.

As such, target dialogue representations for different dialogues are randomly generated on the basis of a constructed grammar, thereby generating different dialogue annotation data. Whereupon, dialogue annotation data in scenarios that support interactions under different intents can be generated.

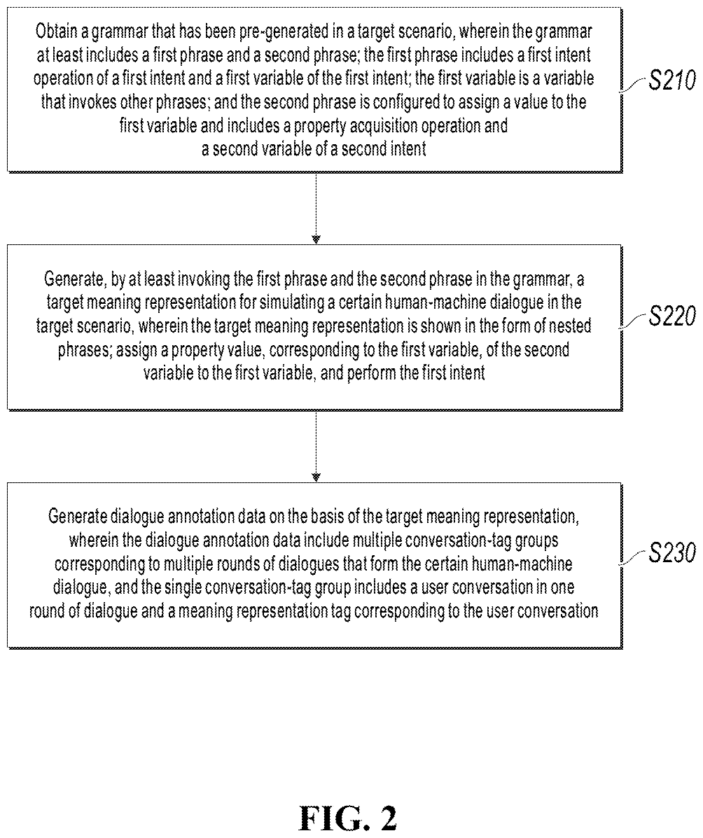

Specific implementation steps of the above solution are described below in combination with more embodiments. FIG. 2 is a flowchart illustrating a method for generating dialogue annotation data according to one or more embodiments. An executive agent of the method can be any apparatus, device, platform, or server cluster that has computing and processing capabilities. As shown in FIG. 2, the method includes the following:

Step S210: A grammar that has been pre-generated in a target scenario is obtained, wherein the grammar at least includes a first phrase and a second phrase; the first phrase includes a first intent operation of a first intent and a first variable of the first intent; the first variable is a variable that invokes other phrases; and the second phrase is configured to assign a value to the first variable and includes a property acquisition operation and a second variable of a second intent. Step 220: A target meaning representation for simulating a certain human-machine dialogue in the target scenario is generated by at least invoking the first phrase and the second phrase in the grammar, wherein the target meaning representation is shown in the form of nested phrases; a property value, corresponding to the first variable, of the second variable is assigned to the first variable; and the first intent operation is performed. Step 230: Dialogue annotation data are generated on the basis of the target meaning representation, wherein the dialogue annotation data include multiple conversation-tag groups corresponding to multiple rounds of dialogues that form the certain human-machine dialogue, and the single conversation-tag group includes a user conversation in one dialogue and a meaning representation tag corresponding to the user conversation.

The above steps are described in detail as follows:

First, in step S210, a grammar that has been pre-generated in a target scenario is obtained. The target scenario involves a plurality of intents. The plurality of intents belong to multiple domains. It should be understood that multiple herein refers to one or more. For example, the multiple domains can include a movie domain, a restaurant domain, a traffic domain, a weather domain, and the like. User intents in the movie domain can include a movie news query intent, a movie ticket reservation intent, a theater query intent, etc. User intents in the restaurant domain can include a table reservation intent, a restaurant finding intent, etc. User intents in the traffic domain can include a road condition query intent, a route query intent, a taxi-hailing intent, etc. User intents in the weather domain can include a weather query intent, an outdoor suggestion intent, etc.

The grammar includes multiple grammar phrases. It should be noted that the grammar phrases can also be referred to as equality relations or function relations. Variables are on the left hand side, and function expressions are on the right hand side. A middle equal sign indicates that a variable value of the left hand side (LHS) variable is equal to an operation result of the right hand side (RHS) function expression. It can be simply recorded as V_{L}=function.

In order to enable a subsequent meaning representation (MR) generated on the basis of the grammar to support intent interactions, the inventor proposes a targeted design of the grammar phrases. Specifically, the inventor has found that the key to achieving the intent interactions is as follows: For two different intents with the same slot, a slot value of one intent in the slot is used to be assigned to the same slot of the other intent. For example, a ‘restaurant finding intent’ and a ‘theater finding intent’ have the same slot ‘location’. Therefore, an intent interaction can be achieved by assigning a theater location using a restaurant location, for example, “a theater near a restaurant”, and vice versa.

Based on this, it is proposed to design at least two different types of grammar phrases. Due to different types of function expressions, for distinguishing, the grammar phrases are separately referred to as a first type of grammar phrase and a second type of grammar phrase.

The function expression in the first type of grammar phrase includes an intent operation and a variable. The variable needs to be assigned by invoking another phrase. It should be noted that the intent operation refers to an operator used for achieving the corresponding intent, and the variable in the function expression usually corresponds to a slot under the intent. In addition, the function expression in the first type of grammar phrase can also be referred to as an intent function. Intuitively, the first type of grammar phrase can be denoted as V_{Li}=operator_intent (v_{R}=$V_{Lj}, . . . ), where operator_intent and v_{R} represent the intent operation and variable in the function expression, respectively; V_{Li} represents the left hand side (LHS) variable of this phrase; V_{Lj} represents the left hand side (LHS) variable of another phrase; $ represents invocation of a phrase; $V_{Lj} represents invocation of the phrase with the left hand side (LHS) variable of V_{Lj}; and v_{R}=$V_{Lj} indicates that the variable v R needs to be assigned by invoking the phrase with the left hand side (LHS) variable of V_{Lj}.

In a case that a meaning representation (MR) uses a function expression (FE), the above intent operation can be implemented as an intent function. Examples of the first type of grammar phrase can include: Restaurant=Find_Restaurant(location=$Location), where the left hand side (LHS) variable is Restaurant; the right hand side (RHS) intent function Find_Restaurant in the function expression represents a function of the restaurant finding intent; location represents a variable corresponding to a geographical location; location=$Location indicates that variable location needs to be assigned by invoking the phrase with the left hand side (LHS) variable of Location.

The first type of grammar phrase is introduced above, and the function expression of the first type of grammar phrase includes the intent operation and the variable.

The function expression in the second type of grammar phrase includes a property acquisition operation and a variable. The property acquisition operation is used for obtaining a property value, corresponding to another variable, of the variable. In addition, the function expression in the second type of grammar phrase can also be referred to as a simple function. Such a function merely operates data, but does not perform the intent operation. Intuitively, the second type of grammar phrase can be denoted as V_{Lj}=get_Property ($V_{Lk}, ‘v_{R}’), where get_Property (or getProp) represents the property acquisition operation, and the function expression represents obtaining a property value, corresponding to variable v_{R}, of variable V_{Lk}. Examples of the second type of grammar phrase can include Location=get_Property ($Theater, ‘location’), where the function expression represents obtaining a variable value, corresponding to variable location, of variable Theater, or examples can further include: Location==get_Property (‘Hualian Theater’, ‘location’), where ‘Hualian Theater’ is a constant variable.

The second type of grammar phrase is introduced above, and the function expression of the second type of grammar phrase includes the property acquisition operation and the variable.

Based on the first type of grammar phrase and the second type of grammar phrase of the above design, grammar phrase pairs that belong to the two types but involve the same variables are further designed, thereby achieving intent interactions and nesting. It should be understood that there can be one or multiple grammar phrase pairs. Any grammar phrase pair (hereinafter referred to as a first grammar phrase pair) is taken as an example for description.

The first grammar phrase pair includes a first phrase belonging to the first type of grammar phrase, and a second phrase belonging to the second type of grammar phrase. The first phrase includes a first intent operation (such as Find_restaurant) of a first intent (such as finding a restaurant) and a first variable (such as location) of the first intent. The first variable is a variable that invokes other phrases. The second phrase (such as the phrase with the left hand side (LHS) variable of Location) is configured to assign a value to the first variable, and includes a property acquisition operation (such as get_property) and a second variable (such as Theater or ‘Hualian Theater’) of the second intent (such as finding a theater). It should be noted that the first intent and the second intent can belong to different domains, or belong to the same domain. For example, in the latter case, the first intent and the second intent are respectively a technology stock recommending intent and a technology stock market query intent, both belonging to the technology stock domain. Furthermore, the same slot of the two intents is a serial number of a technology stock.

From the above, the grammar can support interactions of different intents by designing the grammar phrase pairs mentioned above.

In addition, other types of grammar phrases can also be designed to enrich grammars so as to enrich subsequently generated meaning representations. In one or more embodiments, the grammar also includes a third type of grammar phrase. The function expression of the third type of grammar phrase is character, according to which, the third type of grammar phrase can be denoted as V_{L}=‘char’, where char represents characters. For example, an instance phrase of the third type of grammar phrase can include: MovieType=‘Science Fiction’.

In another embodiment, the grammar also includes a fourth type of grammar phrase. The function expression of the fourth type of grammar includes a referencing operation for a dictionary file, and includes an identifier of the dictionary file. The fourth type of grammar phrase can be denoted as V_{L}=@Dictionary (file_name), representing reference of any value in the dictionary file. The fourth type of grammar phrase can specifically include MovieType=@Dictionary (MovieType), where the function expression represents any movie type in a dictionary file that references movie types.

According to one or more examples, the grammar obtained in this step can include:

Restaurant=find_restaurant(location=$Location);

Location=getProp($Theater,‘location’|getProp($Restaurant,‘location’)|@Dictionary(Locat);

Theater=find_theater(move_type=$Move_type)|find_theater(location=$Location);

$Move_Type=‘Science Fiction’|‘Action’|‘Comedy’|‘Adventure’|.

In the above grammars, the symbol means “or”. It should be understood that in the grammar, different grammar phrases can have the same left hand side (LHS) variables. In this case, these grammar phrases can be combined and recorded.

Based on the above, the content of the grammar has been introduced.

On the other hand, the grammar can be generated automatically or written manually. In the case of automatic generation, in one or more embodiments, first, information of three aspects can be obtained. In the first aspect, scenario information can be obtained, including multiple domains involved in the above target scenario, multiple user intents in the respective domains, and multiple slots of the respective user intents. In the second aspect, dictionary information can be obtained, including dictionaries corresponding to the each slot in the scenario information. The dictionaries include standby slot values. In the third aspect, a template including different types of grammar phrases can be obtained, for example, notations of the different types of grammar phrases disclosed in the above-mentioned embodiments. The grammar is generated on the basis of the information of the three aspects. Specifically, the grammar phrase template can be filled using the scenario information and the dictionary information to generate a plurality of grammar phrases so as to form the above grammar.

From the above, the grammar that has been pre-generated in the target scenario can be obtained. The grammar at least includes the above first phrase and the above second phrase. Then, step S220 can be executed. A target meaning representation for simulating a certain human-machine dialogue in the target scenario is generated by at least invoking the first phrase and the second phrase in the grammar.

Specifically, a grammar phrase is first selected from the grammar to initialize a current meaning representation, and the current meaning representation is then updated by invoking a plurality of other phrases in the grammar one after another until the current meaning representation is unable to perform phrase invocation so as to use the current meaning representation as the target meaning representation. In one or more embodiments, the grammar includes a start phrase with a start symbol (that can be regarded as a special left hand side (LHS) variable), for example: Start=$Restaurant. In this case, in this step, the start phrase can be used to initialize the current meaning representation. In one or more specific embodiments, if there are a plurality of start phrases, the plurality of start phrases can be randomly selected to initialize the current meaning representation. In another embodiment, a grammar phrase can be randomly selected from the grammar as the initial current meaning representation.

Based on this, the implementation of this step includes the following:

1) The above first phrase is invoked to initialize or update the current meaning representation, wherein the first phrase includes the first intent operation (such as find_restaurant) of the first intent and the first variable (such as location). For example, the phrase with the left hand side (LHS) variable of Restaurant in the grammar shown in FIG. 1 can be invoked to initialize the current meaning representation as:

find_restaurant(location=$Location).

2) The first variable is assigned by invoking the second phrase. Specifically, the first variable is assigned with the property value, corresponding to the first variable (such as location), of the second variable (such as Theater) of the second intent in the second phrase so as to update the current meaning representation. In this case, the updated meaning representation includes a nested phrase of the first phrase and the second phrase.

In one or more examples, the phrase with the left hand side (LHS) variable of Location in the grammar shown in FIG. 1 can be invoked to assign variable location in the current meaning representation, and the updated current meaning representation is as follows:

find_restaurant(location=getProp($Theater,‘location’)) (1)

In another example, grammar phrase: location=getProp (‘Hangzhou Jianqiao Theater’, ‘location’) can be invoked to assign variable location in the current meaning representation, and the updated current meaning representation is as follows:

find_restaurant(location=getProp(‘Hangzhou Jianqiao Theater’,‘location’) (2)

3) Afterwards, if the updated meaning representation cannot invoke other phrases, the update is stopped, and the current meaning representation is used as the target meaning representation. In one or more embodiments, if invoking symbol $ is not included in the current meaning representation, it is determined that the current meaning representation cannot invoke other phrases. For example, reference can be made to the above formula (2), excluding invoking symbol $.

If the updated meaning representation can still invoke other phrases, the meaning representation is continuously updated until it cannot invoke other phrases. In one or more embodiments, if invoking symbol $ is included in the current meaning representation, it is determined that the current meaning representation can invoke other phrases. For example, reference can be made to the above formula (1), including invoking symbol $.

The target representation including intent nesting can be achieved through the operations of the above 1) to 3).

In another aspect, it is considered to set parameters of intent nesting to perform at least one of the following: controlling the probability of occurrence of intent nesting and controlling which intents have a higher probability of occurrence of intent nesting, thereby making the generated dialogue annotation data more suitable for data distribution in an actual dialogue scenario. In one or more embodiments, the grammar also includes a third phrase. The third phrase is also configured to assign a value to the first variable. In this case, the second phrase and the third phrase are formally reflected as having the same left hand side (LHS) variables.

Further, in one or more specific embodiments, the third phrase does not include a property acquisition operation, which means that no intent nesting will occur while the third phrase is invoked. In this case, the implementation of this step can include the following: Sampling is performed on the basis of a pre-determined probability of occurrence of intent nesting. In a case that a sampling result indicates that the intent nesting is performed, the second phrase including the property acquisition operation is invoked to assign a value to the first variable in the first phrase, otherwise, the third phrase that does not include a property acquisition operation to assign a value to the first variable in the first phrase.

In another specific embodiment, the third phrase also includes a property acquisition operation and a third variable of a third intent. In this case, the implementation of this step can include the following: Sampling is performed on the basis of a predetermined probability of intent nesting related to the second intent and the third intent. In a case that a sampling result indicates that the second intent is nested, the second phrase is invoked to assign a value to the first variable in the first phrase, otherwise, the third phrase is invoked to assign a value to the first variable in the first phrase.

In still another aspect, the above mainly describes the intent nesting. The inventor has actually found that intent interactions can also include linear combination of intents. A difference between nesting and linear combination is that the former produces a result of one intent operation while the latter produces a result of a plurality of intent operations. In one or more embodiments, the grammar also includes a fifth type of grammar phrase that includes two intent operations of two or more different intents. For a clear description, including two intent operations is taken as an example. Cases of including two or more intent operations can be analogized. Specifically, it is defined that a variable value of a variable of one intent operation is a property value, corresponding to the variable, of an operation result of the other intent operation. It should be noted that the acquisition of the property value can also be achieved on the basis of a property acquisition operation. This type of grammar phrase indicates simultaneous outputting two operation results corresponding to the two intent operations. Intuitively, the fifth type of grammar phrase can be denoted as:

V_{Li}=Operator_1(v_{R1}=$V_{Lj})&Operator_2(v_{R2}=getProp(Operator_1/Result,‘v_{R2}’))
where & represents combining two function expressions, and Operator_1/Result in the latter function expression represents an operation result of the previous function expression. For example, examples of the fifth type of grammar phrase can include the following:

fund=fund_search(1w_yield=‘3%’)&fund_holdings(fund_id=getProp(fund_search/Result,‘fund_id’)
where the function expression in front of & represents querying the fund with a weekly increase or decrease of around 3%, and the function expression behind & represents querying the portfolio of the fund.

Therefore, in this step, grammar phrases belonging to the fifth type of grammar phrase in the grammar can also be invoked to generate the above target representation so as to achieve the linear combination of intents.

In yet another aspect, in one or more embodiments, more than one grammar phrase in the grammar has the same left hand side (LHS) variable, and a grammar phrase is usually invoked using the left hand side (LHS) variable as an index. In this case, sampling weights can be set for the respective grammar phrases. For example, this part of content in the grammar can be denoted as:

V_{L}=[weight_1]function_1|[weight_2]function_2| . . . |[weight_M]function_M

The above equation is a combined notation of M grammar phrases with the same left hand side (LHS) variable of V_{L}, where any function_k represents k function expressions in a kth grammar phrase, and weight_k represents the sampling weight of the kth grammar phrase.

Hence, when a grammar phrase is invoked on the basis of a certain left hand side (LHS) variable in the current meaning representation, if there are a plurality of grammar phrases with this left hand side (LHS) variable, sampling can be performed on the basis of the sampling weights of the respective grammar phrases. It can be understood that a grammar phrase is more likely to be sampled if its sampling weight is larger.

From the above, the target meaning representation that simulates the certain human-machine conversation and supports the intent interaction can be generated by invoking the grammar phrases at least including the first phrase and the second phrase in the grammar.

Then, in step S230, dialogue annotation data on the basis of the target meaning representation, wherein the dialogue annotation data include multiple conversation-tag groups corresponding to multiple rounds of dialogues that form the certain human-machine dialogue, and the single conversation-tag group includes a user conversation in one round of dialogue and a meaning representation tag corresponding to the user conversation.

It should be noted that a single dialogue (also referred to as one dialogue) can include one or more rounds of dialogues. Each round of dialogue includes two conversations, specifically a user conservation and a machine conservation that is a response to the user conservation. The target meaning representation expresses a complete meaning of all the user conservations in the single dialogue, while the meaning representation tag expresses a meaning of the user conservations in a certain round of dialogue in the single dialogue. In addition, the meaning representation tag is in a computer code form executable by a computer.

Considering that the above target meaning representation corresponds to a complete human-machine dialogue, which is relatively complex, the inventor has proposed that the target representation can be divided first, and the dialogue annotation data are then generated. Specifically, in this implementation, the target meaning representation is first divided into a plurality of sub-representations on the basis of a data flow direction in the target meaning representation. The corresponding conversation-tag groups are then generated for the respective sub-representations. Afterwards, the plurality of conversation-tag groups corresponding to the plurality of sub-representations are sequentially concatenated on the basis of the data flow direction to obtain the dialogue annotation data.

In one or more embodiments, the target representation is divided, including the following: The target meaning representation is first divided into a plurality of intent representations of the plurality of user intents involved in the target meaning representation. Group combination is performed on the plurality of intent representations on the basis of the data flow direction to obtain the plurality of sub-representations.

In one or more specific embodiments, the above plurality of user intents correspond to a plurality of intent operations. Correspondingly, the target meaning representation is divided into intent representations on the basis of the intent operations included in the target meaning representation, and a single intent representation obtained by the division includes a single intent operation.

In one or more specific embodiments, the group combination of the plurality of intent representations can be performed randomly as long as it satisfies the data flow direction. In addition, the respective groups of intent representations are often mutually exclusive, meaning that one intent representation will be classified into one group, instead of multiple groups. In one or more examples, two adjacent intent representations can be combined into one sub-representation in sequence. In another example, each of the plurality of intent representations can be directly used as a corresponding sub-representation, so as to divide the target meaning representation into the plurality of sub-representations.

Further, the corresponding conversation-tag groups are generated on the basis of the respective sub-representations. It should be understood that a quantity of the conversation-tag groups can be one or more. In one or more embodiments, for the respective sub-representation, a corresponding conversation template can be obtained on the basis of the intent operations and variables included in the sub-representations. The conversation template can include a user conversation template and a machine conversation template, thereby generating multiple rounds of human-machine dialogues and meaning representation tags of the user conversations in the respective rounds of dialogues on the basis of variable values of the variables in the respective sub-representations.

In one or more examples, for a first sub-representation corresponding to the first intent, a corresponding user conversation template is obtained on the basis of the first intent operation, the first variable, the second variable, and the property acquisition operation, wherein the second variable is used to describe the first variable. A corresponding first user conversation is generated on the basis of the property value of the second variable and the user conversation template, and the first user conversation and the first sub-representation are used as one conversation-tag group.

In one or more examples, the above first sub-representation is FindShow(movie_name=‘Peter Rabbit’, date=getProp (ReserveRestaurant/result, ‘date’)), where the first intent operation involved is FindShow; the first variable is date; and the variable value of the second variable is ReserveRetaurant/result and the property acquisition operation getProp.

Correspondingly, the obtained user conservation template can be as follows: find the movie ______, the day of the reservation at the previous restaurant, so that the generated first user conservation is as follows: find the movie Peter Rabbit, the day of the reservation at the previous restaurant.

As such, the first sub-representation can be used as a meaning tag representation of the first user conservation, thereby forming a conversation-tag group together with the first user conservation.

In addition, a machine conservation template can also be obtained: Theaters that show the movie ______ include ______, ______, thus generating the first machine conservation: Theaters that show the movie Peter Rabbit include the Sky Theater and the Yiteng Theater. The first machine conservation can be used as a conversation preceding text of each user conservation in the subsequent rounds of human-machine dialogues.

As such, the conversation-tag groups corresponding to the representations can be generated by obtaining the conversation templates corresponding to the respective sub-representations. In other embodiments, for the respective sub-representations, a plurality of intents or slots are possibly involved. In this case, a plurality of predefined full matching templates can be obtained to match the sub-representations. Specifically, the matching includes the following:

1) For the respective sub-representations, the scenario information included in the sub-representations is determined, specifically including domains, intents (corresponding to intent operations), and slots (corresponding to operation variables of the intent operations and result variables of the intent operations). For example, assuming that a certain sub-representation is ReserveTicket (departure=‘Beijing’, destination=‘Shanghai’, date=‘Tomorrow’), the scenario information included in the sub-representation can be determined as follows:
Domain: Ticket
Intent: ReserveTicket
Slot:
   inform: departure, destination, date
   request: traininfo

It should be understood that the above inform and request are from the perspective of a user, and it is vice versa from the perspective of a conversation system.

2) Pre-defined full matching templates are also obtained. Each of the matching templates includes information sub-templates and corresponding conversation sub-templates, wherein the information sub-templates include a speaker identity (including a user or a system), a domain, an intent, a slot, and an action (including inform or request). For example, the obtained full matching templates include:

| | |
|---|---|
| USER:TICKET: RESRVETICKET: INFORM: departure | I am going to depart from@ |
| USER:TICKET: RESRVETICKET: INFORM: destination | I will go to@ |
| USER:TICKET: RESRVETICKET: INFORM: date | ticket to @ |
| USER:TICKET: RESRVETICKET: REQUEST: traininfo | What trains are available |
| USER: TICKET: REFUND TICKET: INFORM: traininfo | The train number is@ |
| SYSTEM: TICKET: RESRVETICKET: REQUEST: departure | The departure station is? |
| SYSTEM: TICKET: RESRVETICKET: REQUEST: destination | The destination station |

is?

| | |
|---|---|
| SYSTEM: TICKET: RESRVETICKET: REQUEST: date | Date? |
| SYSTEM: TICKET: RESRVETICKET: INFORM: traininfo | Trains for that day include@ |

In the above matching templates, the information sub-template and the conversation sub-template are on the left hand side, and @ represents a slot value of a corresponding slot.

3) Further, the above information sub-templates can be matched using the determined scenario information and a current speaker (the user and the system are alternated), thereby generating corresponding conservations using the conservation sub-templates corresponding to the successfully matched information sub-templates. In one or more specific embodiments, in certain matching, there are a plurality of successfully matched information sub-templates. In this case, one of the information sub-templates can be randomly selected, or all the information sub-templates can be selected. In one or more specific embodiments, if the slot value of a slot in the scenario information has already appeared in a conservation, the scenario information is updated by deleting the slot. Afterwards, the updated scenario information is used to continue to match the information sub-templates until the updated scenario information does not include the slot. As such, the plurality of rounds of dialogues corresponding to the sub-representations can be generated.

In another aspect, in a case that the speaker in each round of dialogue is the user, a corresponding unit meaning representation is extracted as the meaning representation tag of the user conservations in this round of dialogue from the sub-representation on the basis of the information sub-template that is matched successfully and selected at this time and the intent and slot included in the sub-representation.

From the above, by obtaining the full matching templates composed of the information sub-templates and the conversation sub-templates and determining the scenario information in the sub-representations, the dialogue annotation data corresponding to the sub-representations can be generated.

In another embodiment, an existing agenda-based dialogue data generation manner can be used to generate the corresponding human-machine dialogue and the meaning representation tags of the user conservations in the human-machine dialogue.

From the above, the conversation-tag groups corresponding to the respective sub-representations can be generated. Further, the plurality of conversation-tag groups corresponding to the plurality of sub-representations can be sequentially concentrated to obtain the above dialogue annotation data

In the above implementations, the target representation is first divided before the dialogue annotation data are generated. User phrases in the generated dialogue annotation data are more natural and in line with human natural language habits.

In another implementation, the above grammar also includes user conservation generation templates corresponding to the respective grammar phrases. It can be denoted as V_{L}=function[template_text], where template_text represents a user conservation generation template. For example, the grammar includes:

RestaurantReservation=ReserveRestaurant(restaurant_name=$RestaurantName,date=$Date,time=$Time,group_size=$COUNT)[reserve table for #1,#2,#3,#4 persons]

where #i represents a text generated by referencing a phrase based on an ith $ symbol index.

Based on this, when the grammar phrases in the grammar are invoked one after another to initialize and update the current meaning representation by executing the above step S220, the corresponding user conservation generation templates can be synchronously invoked to initialize and update a current user conservation, so that the current user conservation that is stopped being updated can be used as a target user conservation. Therefore, in this step, the target meaning representation can be directly used as the meaning representation tag of the target user conservation, thereby obtaining the conversation-tag group that includes the target user conservation and the corresponding meaning representation tag.

As such, the dialogue annotation data can be quickly generated by designing the user conservation templates corresponding to the grammar phrases in the grammar.

In still another implementation, for the above target representation, the corresponding human-machine dialogue and the meaning representation tags of the user conservations in the human-machine dialogue can be generated directly on the basis of the above full matching templates or by using an existing agenda-based dialogue data generation manner.

From the above, a certain human-machine dialogue can be simulated, and the corresponding dialogue annotation data can be generated in a simultaneous manner. Based on the embodiments of another aspect, the method can further include the following: A user conversation-oriented semantic parsing model in a human-machine dialogue scenario is trained by using the dialogue annotation data. Since the meaning representation tags involved in the dialogue annotation data involve intent nesting and linear intent combination, the trained semantic parsing model can be used in the target scenario, including a single-domain multi-intent scenario, and even a multi-domain multi-intent scenario.

In conclusion, the methods for generating the dialogue annotation data provided by the embodiments of this specification are used to obtain a pre-generated grammar that supports intent interactions in a target scenario, invoke specific types of grammar phrases on the basis of the grammar, generate a target meaning representation including nested intents, then simulate a certain human-machine conversation on the basis of the target meaning representation, and generate multiple conversation-tag groups corresponding to multiple rounds of conversations as dialogue annotation data. In at least one conversation-tag group in the dialogue annotation data, a meaning representation tag includes a nested or linear combination of intents, and a corresponding user conversation includes using a slot of one intent to describe the same slot of another intent. As such, the dialogue annotation data for human-machine interactions in a multi-intent scenario are generated.

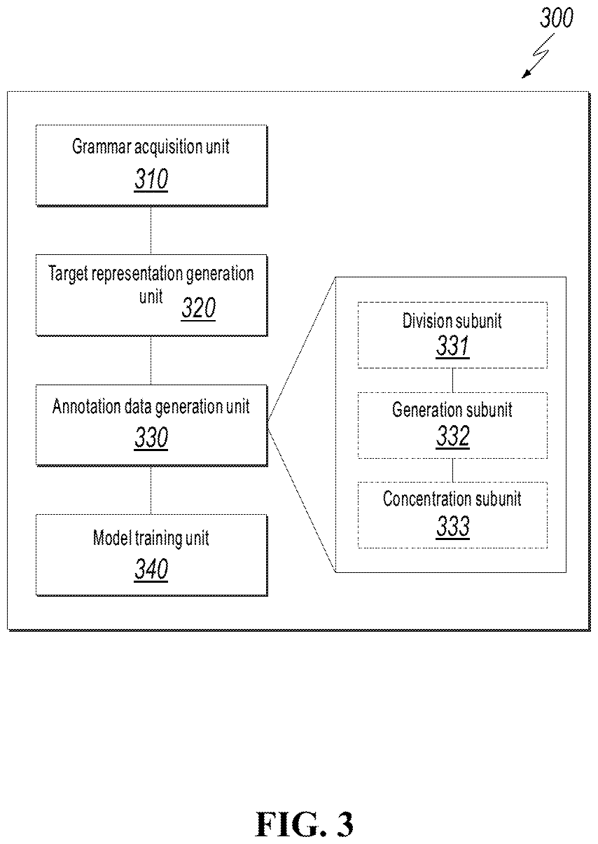

Corresponding to the above methods for generating the dialogue annotation data, the embodiments of this specification further disclose apparatuses for generating dialogue annotation data. FIG. 3 is a schematic structural diagram illustrating an apparatus for generating dialogue annotation data according to one or more embodiments. As shown in FIG. 3, the apparatus 300 includes:
a grammar acquisition unit 310, configured to obtain a grammar that has been pre-generated in a target scenario, wherein the grammar at least includes a first phrase and a second phrase; the first phrase includes a first intent operation of a first intent and a first variable of the first intent; the first variable is a variable that invokes other phrases; and the second phrase is configured to assign a value to the first variable and includes a property acquisition operation and a second variable of a second intent; a target representation generation unit 320, configured to generate, by at least invoking the first phrase and the second phrase in the grammar, a target meaning representation for simulating a certain human-machine dialogue in the target scenario, wherein the target meaning representation is shown in the form of nested phrases; assign a property value, corresponding to the first variable, of the second variable to the first variable, and perform the first intent operation; and an annotation data generation unit 330, configured to generate dialogue annotation data on the basis of the target meaning representation, wherein the dialogue annotation data include multiple conversation-tag groups corresponding to multiple rounds of dialogues that form the certain human-machine dialogue, and the single conversation-tag group includes a user conversation in one round of dialogue and a meaning representation tag corresponding to the user conversation.

In one or more embodiments, the grammar acquisition unit 310 is specifically configured to obtain scenario information, wherein the scenario information includes multiple domains involved in the target scenario, multiple user intents in the respective domains, and multiple slots under the respective user intents; obtain dictionary information, wherein the dictionary information includes dictionaries corresponding to each slot, and the dictionaries include candidate slot values of the corresponding slots; and generate the grammar on the basis of the scenario information, the dictionary information, and a predefined phrase template.

In one or more embodiments, the first intent and the second intent belong to the same domain or different domains.

In one or more embodiments, the grammar includes a start phrase with a start symbol. The target representation generation unit 320 is specifically configured to use the start phrase as a current meaning representation, and update the current meaning representation by invoking a plurality of other phrases in the grammar one after another until the current meaning representation is unable to perform phrase invocation so as to use the current meaning representation as the target meaning representation, wherein the plurality of phrases include the first phrase and the second phrase.

In one or more specific embodiments, the grammar further includes a third phrase; and the third phrase involves a third intent and is configured to assign a value to the first variable. The target representation generation unit 320 is further configured to select, after the first phrase is invoked, one of the second phrase and the third phrase on the basis of a predetermined intent nesting probability related to the second intent and the third intent; and invoke, in a case that a selection result indicates that the second phrase is selected, the second phrase to assign a value to the first variable.

In one or more embodiments, the grammar further includes a fourth phrase; the fourth phrase includes a third intent operation of a third intent, a fourth intent operation of a fourth intent, and a fourth variable of the fourth intent, and a variable value of the fourth variable is defined as; an operation result of the third intent operation corresponds to a property value of the fourth variable; and the fourth phrase indicates simultaneously outputting the operation result of the third intent operation and an operation result of the fourth intent operation.

In one or more embodiments, the annotation data generation unit 330 includes a division subunit 331, configured to divide the target meaning representation into a plurality of sub-representations on the basis of a data flow direction in the target meaning representation; generation subunit 332, configured to generate the corresponding conversation-tag groups for the respective sub-representations; and a concentration subunit 333, configured to sequentially concentrate the plurality of conversation-tag groups corresponding to the plurality of sub-representations to obtain the dialogue annotation data.

In one or more specific embodiments, the target meaning representation involves a plurality of user intents; and the division subunit 331 is specifically configured to divide the target meaning representation into a plurality of intent representations corresponding to the plurality of user intents; and perform group combination on the plurality of intent representations on the basis of the data flow direction to obtain the plurality of sub-representations.

Further, in one or more specific embodiments, the division subunit 331 is further configured to use each of the plurality of intent representations as a corresponding sub-representation.

Much further, in one or more examples, the generation subunit 332 is further configured to: for a first sub-representation corresponding to the first intent, obtain a corresponding user conversation template on the basis of the first intent operation, the first variable, the second variable, and the property acquisition operation, wherein the second variable is used to describe the first variable; generate a corresponding first user conversation on the basis of the property value of the second variable and the user conversation template; and use the first user conversation and the first sub-representation as one conversation-tag group.

In one or more embodiments, the grammar includes a plurality of phrases and user conversation generation templates corresponding to the respective phrases. The target representation generation unit 320 is specifically configured to generate the target meaning representation by invoking some phrases in the grammar, and generate a corresponding target user conversation by invoking some user conversation generation templates corresponding to the phrases. The annotation data generation unit 330 is specifically configured to generate one conversation-tag group by using the target meaning representation as the meaning representation tag of the target user conversation.

In one or more embodiments, the meaning representation tag is in a computer code form executable by a computer.

In one or more embodiments, the apparatus further includes a model training unit 340, configured to train a user conversation-oriented semantic parsing model in a human-machine dialogue scenario by using the dialogue annotation data.

In conclusion, the apparatuses for generating the dialogue annotation data provided by the embodiments of this specification are used to obtain a pre-generated grammar that supports intent interactions in a target scenario, invoke specific types of grammar phrases on the basis of the grammar, generate a target meaning representation including nested intents, then simulate a certain human-machine conversation on the basis of the target meaning representation, and generate multiple conversation-tag groups corresponding to multiple rounds of conversations as dialogue annotation data. In at least one conversation-tag group in the dialogue annotation data, a meaning representation tag includes a nested or linear combination of intents, and a corresponding user conversation includes using a slot of one intent to describe the same slot of another intent. As such, the dialogue annotation data for human-machine interactions in a multi-intent scenario are generated.

According to the embodiments of another aspect, a computer-readable storage medium is further provided, storing a computer program. The computer program, when run in a computer, causes the computer to perform the method described in FIG. 2.

According to the embodiments of still another aspect, a computer device is further provided, including a memory and a processor. The memory stores an executable code, and when executing the executable code, the processor implements the method described in FIG. 2. A person skilled in the art should be aware that in one or more of the above examples, the functions described in this application can be implemented using hardware, software, firmware, or any combination of them. When implemented using software, these functions can be stored in the computer-readable medium or transmitted as one or more instructions or codes on computer-readable medium.

The specific implementations mentioned above provide further detailed explanations of the objectives, technical solutions, and beneficial effects of this application. It should be understood that the above descriptions are merely specific implementations of this application and are not intended to limit the protection scope of this application. Any modifications, equivalent replacements, improvements, etc. made on the basis of the technical solutions of this application should all fall within the protection scope of this application.

What is claimed is:

1. A computer-implemented method for generating dialogue annotation data, comprising:
obtaining a grammar that has been pre-generated in a target scenario, wherein the grammar at least comprises:
a first phrase and a second phrase, wherein the first phrase comprises a first intent operation of a first intent and a first variable of the first intent, wherein the first variable is a variable that invokes other phrases, and wherein the second phrase is configured to assign a value to the first variable and comprises:
a property acquisition operation and a second variable of a second intent;
generating, by at least invoking the first phrase and the second phrase in the grammar, a target meaning representation for simulating a certain human-machine dialogue in the target scenario, wherein the target meaning representation is shown in a form of nested phrases;
assigning a property value, corresponding to the first variable, of the second variable to the first variable, and performing the first intent operation; and
generating dialogue annotation data based on the target meaning representation, wherein the dialogue annotation data comprises multiple conversation-tag groups corresponding to multiple rounds of dialogues that form the certain human-machine dialogue, and wherein a single conversation-tag group comprises a user conversation in one round of dialogue and a meaning representation tag corresponding to the user conversation.

2. The computer-implemented method of claim 1, wherein the obtaining a grammar that has been pre-generated in a target scenario comprises:
obtaining scenario information that comprises multiple domains involved in the target scenario, multiple user intents in the respective domains, and multiple slots under the respective user intents.

3. The computer-implemented method of claim 2, comprising:
obtaining dictionary information that comprises one or more dictionaries corresponding to each slot, and the dictionaries comprise candidate slot values of each slot.

4. The computer-implemented method of claim 3, comprising:
generating the grammar based on the scenario information, the dictionary information, and a predefined phrase template.

5. The computer-implemented method of claim 1, wherein the first intent and the second intent belong to a same domain or different domains.

6. The computer-implemented method of claim 1, wherein:
the grammar comprises a start phrase with a start symbol.

7. The computer-implemented method of claim 6, comprising:
generating, by at least invoking the first phrase and the second phrase in the grammar, a target meaning representation for simulating a certain human-machine dialogue in the target scenario, comprises:
using the start phrase as a current meaning representation; and
updating the current meaning representation by invoking a plurality of other phrases in the grammar one after another until the current meaning representation is unable to perform phrase invocation so as to use the current meaning representation as the target meaning representation, wherein the plurality of other phrases comprise the first phrase and the second phrase.

8. The computer-implemented method of claim 7, wherein:
the grammar further comprises a third phrase;
the third phrase involves a third intent and is configured to assign a value to the first variable, wherein the updating the current meaning representation by invoking a plurality of other phrases in the grammar one after another comprises:
after the first phrase is invoked, selecting one of the second phrase and the third phrase based on a predetermined intent nesting probability related to the second intent and the third intent; and
in a case that a selection result indicates that the second phrase is selected, invoking the second phrase to assign a value to the first variable.

9. The computer-implemented method of claim 1, wherein:
the grammar further comprises a fourth phrase;
the fourth phrase comprises a third intent operation of a third intent, a fourth intent operation of a fourth intent, and a fourth variable of the fourth intent, and a variable value of the fourth variable is defined as an operation result of the third intent operation corresponding to a property value of the fourth variable; and
the fourth phrase indicates simultaneously outputting the operation result of the third intent operation and an operation result of the fourth intent operation.

10. The computer-implemented method of claim 1, wherein generating dialogue annotation data based on the target meaning representation, comprises:
dividing the target meaning representation into a plurality of sub-representations based on a data flow direction in the target meaning representation;
generating corresponding conversation-tag groups for respective sub-representations; and
sequentially concentrating a plurality of conversation-tag groups corresponding to the plurality of sub-representations to obtain the dialogue annotation data.

11. The computer-implemented method of claim 10, wherein the target meaning representation involves a plurality of user intents; and the dividing the target meaning representation into a plurality of sub-representations based on a data flow direction in the target meaning representation, comprises:
dividing the target meaning representation into a plurality of intent representations corresponding to the plurality of user intents; and
performing group combination on the plurality of intent representations based on the data flow direction to obtain the plurality of sub-representations.

12. The computer-implemented method of claim 11, wherein the performing group combination on the plurality of intent representations based on the data flow direction to obtain the plurality of sub-representations, comprises:
using each of the plurality of intent representations as a corresponding sub-representation.

13. The computer-implemented method of claim 12, wherein generating corresponding conversation-tag groups for respective sub-representations, comprises:
for a first sub-representation corresponding to the first intent, obtaining a corresponding user conversation template based on the first intent operation, the first variable, the second variable, and the property acquisition operation, wherein the second variable is used to describe the first variable.

14. The computer-implemented method of claim 13, comprising:
generating a corresponding first user conversation based on the property value of the second variable and the corresponding user conversation template.

15. The computer-implemented method of claim 14, comprising:
using the corresponding first user conversation and the first sub-representation as one conversation-tag group.

16. The computer-implemented method of claim 1, wherein the grammar comprises a plurality of phrases and user conversation generation templates corresponding to respective phrases, and wherein generating, by at least invoking the first phrase and the second phrase in the grammar, a target meaning representation for simulating a certain human-machine dialogue in the target scenario, comprises:
generating the target meaning representation by invoking some phrases in the grammar, and generating a corresponding target user conversation by invoking some user conversation generation templates corresponding to the phrases, wherein generating dialogue annotation data based on the target meaning representation, comprises:
generating one conversation-tag group by using the target meaning representation as the meaning representation tag of the corresponding target user conversation.

17. The computer-implemented method of claim 1, wherein the meaning representation tag is in a computer code form executable by a computer.

18. The computer-implemented method of claim 1, further comprising:
training a user conversation-oriented semantic parsing model in a human-machine dialogue scenario by using the dialogue annotation data.

19. A non-transitory, computer-readable medium storing one or more instructions executable by a computer system to perform one or more operations for generating dialogue annotation data, comprising:
obtaining a grammar that has been pre-generated in a target scenario, wherein the grammar at least comprises:
a first phrase and a second phrase, wherein the first phrase comprises a first intent operation of a first intent and a first variable of the first intent, wherein the first variable is a variable that invokes other phrases, and wherein the second phrase is configured to assign a value to the first variable and comprises:
a property acquisition operation and a second variable of a second intent;
generating, by at least invoking the first phrase and the second phrase in the grammar, a target meaning representation for simulating a certain human-machine dialogue in the target scenario, wherein the target meaning representation is shown in a form of nested phrases;
assigning a property value, corresponding to the first variable, of the second variable to the first variable, and performing the first intent operation; and
generating dialogue annotation data based on the target meaning representation, wherein the dialogue annotation data comprises multiple conversation-tag groups corresponding to multiple rounds of dialogues that form the certain human-machine dialogue, and wherein a single conversation-tag group comprises a user conversation in one round of dialogue and a meaning representation tag corresponding to the user conversation.

20. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations for generating dialogue annotation data, comprising:
obtaining a grammar that has been pre-generated in a target scenario, wherein the grammar at least comprises:
a first phrase and a second phrase, wherein the first phrase comprises a first intent operation of a first intent and a first variable of the first intent, wherein the first variable is a variable that invokes other phrases, and wherein the second phrase is configured to assign a value to the first variable and comprises:
a property acquisition operation and a second variable of a second intent;
generating, by at least invoking the first phrase and the second phrase in the grammar, a target meaning representation for simulating a certain human-machine dialogue in the target scenario, wherein the target meaning representation is shown in a form of nested phrases;
assigning a property value, corresponding to the first variable, of the second variable to the first variable, and performing the first intent operation; and
generating dialogue annotation data based on the target meaning representation, wherein the dialogue annotation data comprises multiple conversation-tag groups corresponding to multiple rounds of dialogues that form the certain human-machine dialogue, and wherein a single conversation-tag group comprises a user conversation in one round of dialogue and a meaning representation tag corresponding to the user conversation.
